(19) United States
(12) Patent Application Publication
(10) Pub. No.: US 2007/0081503 A1
(43) Pub. Date: Apr. 12, 2007

(54) System and method for evaluating operation of a wireless device in a wireless network

(76) Inventor: Carl Mower, San Jose, CA (US)

Correspondence Address: FAY KAPLUN & MARCIN, LLP, 15O BROADWAY, SUITE 702, NEW YORK, NY, 10038, US

(21) Appl. No.: 11/245,569

(22) Filed: Oct. 7, 2005

(51) Int. Cl. H04Q 7/24

(52) U.S. Cl. 370/338

(57) ABSTRACT

Described is a system including first and second access points and a switch. The first access point transmits a radio frequency signal. The second access point receives the signal and detects a signal strength of the signal. The switch receives the signal strength from the second access point and generates output data as a function of the signal strength and a predetermined signal strength. The switch executes a predetermined procedure which corresponds to the output data.

### BACKGROUND INFORMATION

During design or deployment of a wireless network, a placement of access points/ports (“APs”) is critical to ensuring a resilient radio frequency (“RF”) coverage throughout the network. However, the network is frequently utilized in a physical landscape (e.g., a retail store, a warehouse) in which changes thereto may cause the RF coverage to be weakened or completely lost. For example, a post design/deployment change (e.g., adding, removing and/or rearranging items) within the landscape may result in a weaker signal transmitted and/or received by the APs.

In anticipation of the change(s), a network administrator, during design and simulation of the network, may attempt to compensate for the landscape of the network when using a network-design software. However, a simulation of the network is only as good as an input received (e.g., a floor plan). That is, the floor plan may not provide an accurate model, because it may not account for RF propagation characteristics of items therein (e.g., walls, doors, windows) and any changes which are made to the network after deployment.

After deployment, the network administrator may utilize a trial-and-error approach by repeatedly repositioning the APs until a satisfactory result is obtained (e.g., a strong signal strength). This approach is problematic in that it requires a significant amount of time, during which, the network may be operating at a reduced efficiency.

Even after installation of the APs, the AP may experience a partial or a total failure. For example, a directional antenna of the AP may become dislodged or redirected. Also, the AP may have been installed adjacent to an object (e.g., a metal structure) which would diminish RF propagation characteristics of the signals to/from the AP. Thus, there is a need for identifying these conditions during operation of the network (i.e., after design and/or installation).

### SUMMARY OF THE INVENTION

The present invention relates to a system including first and second access points and a switch. The first access point transmits a radio frequency signal. The second access point receives the signal and detects a signal strength of the signal. The switch receives the signal strength from the second access point and generates output data as a function of the signal strength and a predetermined signal strength. The switch executes a predetermined procedure which corresponds to the output data.

### BRIEF DESCRIPTION OF THE DRAWINGS

FIG. 1 is an exemplary embodiment of a system according to the present invention;

FIG. 2 is an exemplary embodiment of a signal table according to the present invention;

FIG. 3 is an exemplary embodiment of a method according to the present invention; and

FIG. 4 is an exemplary embodiment of another system according to the present invention.

### DETAILED DESCRIPTION

The present invention may be further understood with reference to the following description and the appended drawings, wherein like elements are provided with the same reference numerals. The present invention provides a system and a method for evaluating operation of a wireless device in a wireless network. An exemplary embodiment of the present invention will be described in the context of an enclosed space (e.g., a store, a warehouse, etc.). However, one skilled in the art will understand that the present invention is not limited to such a space, but may be utilized in any environment which employs the wireless network.

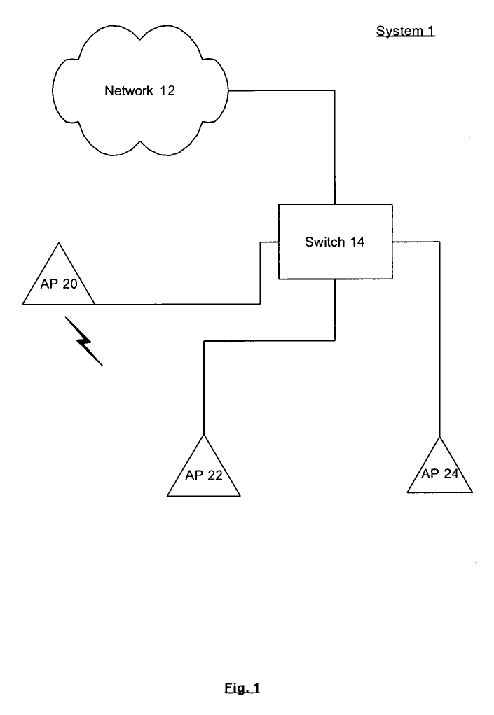

FIG. 1 shows an exemplary embodiment of a system 1 deployed in the space according to the present invention. The system 1 may include a network management arrangement (e.g., a switch 14) coupled to a communications network 12. The switch 14 may include one or more components and/or devices for sending and receiving a data request, and may further include a storage medium (e.g., a memory) or be coupled to a stand-alone storage device (e.g., a database). The switch 14 may store data about the network 12 including an operational status, an RF coverage area, a MAC address and a physical location of each wireless device connected to the network 12. This data may be utilized for management and evaluation of the network 12, as will be described below. The network 12 may be any communications network (e.g., LAN, WAN, Internet, etc.) comprising one or more infrastructure components (e.g., hubs, switches, servers, etc.).

The switch 14 may be coupled to one or more access points/ports (“APs”) 20,22,24 which provide a wireless connection for one or more mobile units to the network 12. That is, the APs 20-24 may be any device which converts a packet format from a wired communication protocol (e.g., TCP/IP) to a wireless communication protocol (e.g., an 802.11 protocol), and vice-versa. Those of skill in the art will understand the mobile unit may be, for example, an image- or laser-based scanner, an RFID reader, a cell phone, a laptop, a network interface card, a handheld computer, a PDA, etc. Further understood by those of skill in the art is that any number of APs may be coupled to the switch 14.

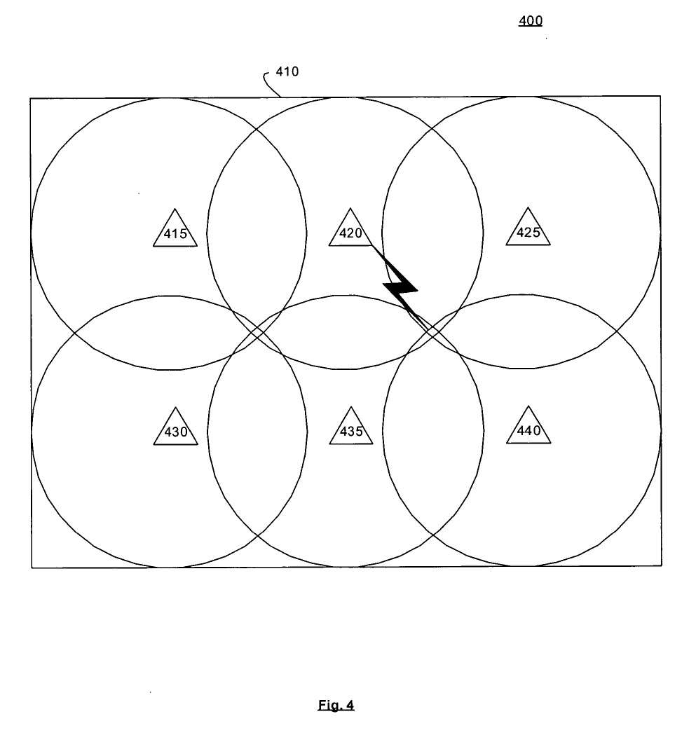

While the present invention will be described with reference to the system 1 shown in FIG. 1, other embodiments of the system may be implemented. For example, FIG. 4 shows a exemplary system 400 which may be utilized in accordance with the present invention. Similar to the system 1, the system 400 may be deployed in a space 410, such as, for example, a store or a warehouse. In this embodiment, a plurality of APs 415-440 are deployed throughout the space 410 with a goal of providing resilient wireless coverage to any mobile unit operating therein. Thus, radio frequency (“RF”) coverage areas (shown as circles around the APS 415-440) may overlap. As such, a signal transmitted by one AP (e.g., AP 420) may be heard by one or more of the APs 415, 425-440 if they are tuned to a same channel as the AP 420. A switch may be coupled to each of the APs 415-440 and evaluate operation of each in accordance with the present invention.

Referring back to FIG. 1, the AP 20 may broadcast a wireless signal (e.g., a beacon) at a predetermined interval (e.g., every 100 ms). Those of skill in the art will understand that while the present invention will be explained with respect to the AP 20, the APs 24 and 26 and any further APs may be utilized. Further, between a transmission of the beacon and a subsequent beacon, the AP 20 may communicate with the mobile unit, the APs 24 and 26 and/or the switch 14.

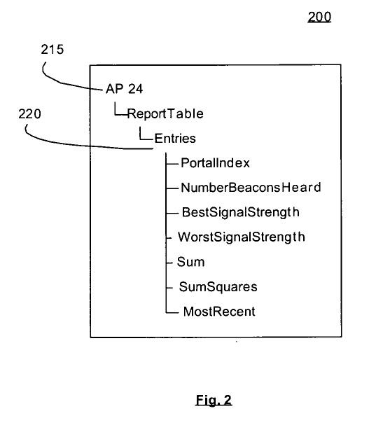

Each AP which is tuned to a same RF channel as the AP 20 may receive the beacon. For example, the AP 24 may be tuned to the channel and receive the beacon(s) broadcasted by the AP 20. According to the present invention, upon receipt of the beacon, the AP 24 may identify a signal data of the beacon which may include a signal strength thereof. The AP 24 may record and store the signal data in a signal table 200, as shown in FIG. 2. In one embodiment, the signal table 200 may be a management information base (“MIB”) which may include a primary index 215 indicative of the AP which transmitted the beacon (e.g., the AP 20) and a secondary index 220 including one or more data entries indicative of one or more characteristic(s) of the beacon and a prior beacon(s) from the AP (e.g., the AP 20).

The data entries may be included as branches of the secondary index 220. The data entries may include the signal data which is indicative of the one or more characteristics of one or more beacons transmitted by the AP 20 and received by the AP 24. For example, the data entries may include the signal data corresponding to a number of beacons received, a strongest/weakest signal strength of the beacons, a sum of the signal strengths of the beacons, a sum of squares of the signal strengths of the beacons and a signal strength of a most recently received beacon. In this manner, each AP may include a unique signal table including the signal data for the beacon(s) received thereby.

In operation, when the beacon is received, the AP 24 may update the signal data in the signal table 200. For example, the AP 24 may input the signal strength of the beacon as the signal strength of the most recently received beacon (e.g., in a “MostRecent” data entry). The AP 24 may incorporate the signal strength into the sum and the sum of squares of the signal strengths. The AP 24 may further determine whether the signal strength is a best (i.e., strongest) or a worst (i.e., weakest) of all prior beacons which have been received from the AP 20. If so, the signal strength may be inputted into a “BestSignalStrength“field or a “WorstSignalStrength” field. Thus, the AP 24 may continually update the signal table 200 after receipt of each beacon from any AP which is transmitting on the same channel as the AP 24.

The switch 14 may utilize the signal data to evaluate operation of the APs 20-24. In one embodiment, the switch 14 utilizes a predetermined network management protocol (e.g., a Simple Network Management Protocol (“SNMP”)) to harvest the signal data from the APs 20-24, which may be SNMP-compliant devices. In this embodiment, the switch 14 may be provided with and/or request the signal data from the APs 20-24.

Upon receipt of the signal data, the switch 14 may compare the signal data to stored data. In one embodiment, the stored data may include simulation data obtained from a simulation of the RF environment generated by, for example, the network design software. The software may take into account a type (e.g., a power-setting, an RF range, etc.) and a location of each AP, a physical environment of the network (e.g., layout, walls, windows, doors, etc.) and RF propagation characteristics of the physical environment. In another embodiment, the stored data may include deployment data collected after deployment of the network. For example, the APs 20-24 may generate the signal table 200 and gather the deployment data after deployment of the network and report the deployment data to switch 14, which stores the deployment data as the stored data. In a further embodiment, the stored data may include operational data collected during operation of the network. As understood by those of skill in the art, the operational data may conform most closely to the signal data.

The comparison of the signal data to the stored data may generate output data which may be indicative of a predetermined condition (e.g., input to the network design software was incomplete). For example, an actual physical environment may differ from a designed physical environment due to construction difficulties (e.g., a wall could not be built). Thus, the simulation of the RF environment would not have accounted for a component(s) of the actual physical environment which differs from the designed physical environment. Thus, the output data may be indicative of a difference between the designed and actual physical environments.

The output data may further indicate that the APs are not installed in their corresponding predetermined locations. That is, the simulation may include the predetermined location of each AP in the network, whereas an actual location of the AP may differ therefrom. For example, when the AP 20 was being installed, it may have been affixed to a wall rather than a ceiling, as intended. Also, the AP 20 may have one or more directional antennas, which may have been incorrectly oriented (e.g., upside-down) during or after installation. Either of these instances may alter the RF propagation characteristics of the AP 20.

Furthermore, the output data may be indicative of a post-installation change. For example, the AP 20 may become dislodged, the antenna may be unintentionally re-oriented and/or items may be stacked around the AP 20. The post-installation change may also alter the RF propagation characteristics of the AP 20.

During operation of the network, the switch 14 may compare the signal data to the stored data to generate the output data, and evaluate performance of the APs as a function of the output data. The signal data may be used to verify the simulation of the RF environment and/or detect installation errors, changes in the physical environment which affect the RF environment and/or failures/malfunctions of the APs. When the performance of the AP falls below a threshold, the switch 14 may execute a predetermined action such as, for example, alerting an administrator and/or maintenance staff.

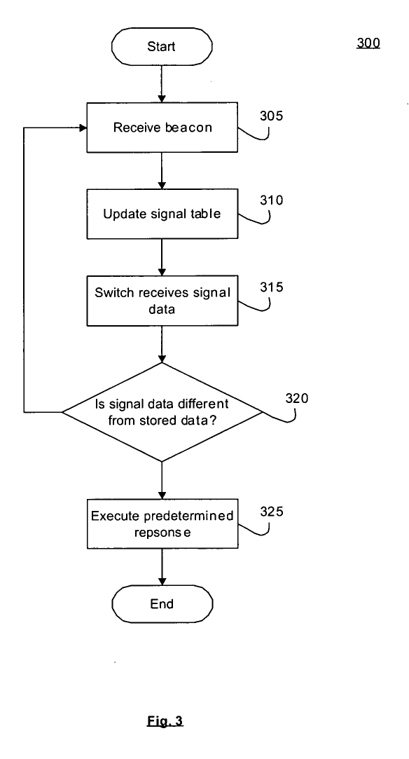

FIG. 3 shows an exemplary embodiment of a method 300 according to the present invention. In step 305, the AP 24 receives the beacon transmitted by the AP 20. As stated above, the AP 24 may hear the beacon(s) of any AP which is transmitting on the RF channel to which the AP 24 is currently tuned. Thus, those of skill in the art will understand that the AP 24 may receive a plurality of beacons from a corresponding plurality of APs, and list each AP in the primary index 215 of the signal table 200.

In step 310, the AP 24 updates the signal table 200 with the signal data from the beacon. The “MostRecent” field may be updated after each beacon is received from the AP 20. The AP 24 may then determine whether to update the “BestSignalStrength” and/or the “WorstSignalStrength” fields.

In step 315, the signal data is provided to the switch 14. The switch 14 may harvest the signal data from the APs 20-24 at a predetermined time/interval. That is, the switch 14 may transmit a request for the signal data to each of the APs 20-24. As described above, the request and a resulting response (including the signal data) from the APs may be executed according to the SNMP.

In step 320, the switch 14 compares the signal data to the stored data to generate the output data which may be indicative of a problem with the AP 20. In one exemplary embodiment, the switch 14 compares the signal strength of the beacon to a stored signal strength which may be a predetermined range and/or value (e.g., a minimum signal strength). When the signal strength is within the predetermined range and/or greater than the value, the method 300 returns to step 305 whereby the AP 24 receives a further beacon from the AP 20.

In step 325, the signal strength is outside of the predetermined range, so the switch 14 executes a predetermined response. In one embodiment, the switch 14 may transmit an alert to a server notifying a network administrator that a problem may exist with respect to the AP 20. The alert may include a location of the AP 20 and a problem type (e.g., low signal strength, erroneous antenna orientation, etc.). The alert may indicate that the AP 20 has experienced a partial or total malfunction and/or is emitting a weak signal. In another embodiment, the switch 14 may take the AP 20 offline and boost power to the APs 22 and 24 to extend the RF coverage areas thereof compensating for a removal of the AP 20.

The present invention may provide an advantage of a real-time assessment of the APs 20-24 while in operation. In this manner, the network administrator may be notified when a performance of the AP drops below a simulated/expected performance. Thus, the AP may be repaired and/or replaced to maintain an integrity of the RF environment.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A system, comprising:
a first access point transmitting a radio frequency signal;
a second access point receiving the signal and detecting a signal strength of the signal; and
a switch coupled to the second access point and receiving the signal strength from the second access point, the switch generating output data as a function of the signal strength and a predetermined signal strength,
wherein the switch executes a predetermined procedure which corresponds to the output data.

2. The system according to claim 1, wherein the radio frequency signal is a beacon.

3. The system according to claim 1, wherein the second access point generates a signal table storing the signal strength and at least one of (i) a strongest signal strength of a beacon received from the first access point, (ii) a weakest signal strength of a beacon received from the first access point, (iii) a sum of the signal strengths of all beacons received from the first access point and (iv) a sum of squares of the signal strengths of all beacons received from the first access point.

4. The system according to claim 3, wherein the signal table is a management information base.

5. The system according to claim 3, wherein the second access point updates the signal table for each subsequent beacon received from the first access point.

6. The system according to claim 1, wherein the switch utilizes a predetermined network management protocol to communicate with the second access point.

7. The system according to claim 6, wherein the protocol is a Simple Network Management Protocol.

8. The system according to claim 1, wherein the switch compares the signal strength to the predetermined signal strength, and when the signal strength is outside of a predetermined range of the predetermined signal strength, the switch executes the predetermined procedure.

9. The system according to claim 1, wherein the predetermined signal strength is generated during at least one of (i) a simulation of communication between the first and second access points and (ii) post-deployment communication between the first and second access points.

10. The system according to claim 1, wherein the output data is indicative of at least one of (i) at least one of the first and second access points is not in a corresponding predetermined location, (ii) a malfunction of at least one of the first and second access points and (iii) a difference between a designed physical environment and an actual physical environment in which the first and second access points are situated.

11. The system according to claim 1, wherein the predetermined procedure includes an alert transmitted to a network administrator by the switch.

12. A method, comprising:
transmitting a radio frequency signal by a first access point;
receiving the signal by a second access point;
detecting, by the second access point, a signal strength of the signal;
receiving the signal strength from the second access point by a switch;
generating output data by the switch as a function of the signal strength and a predetermined signal strength; and
executing a predetermined procedure which corresponds to the output data.

13. The method according to claim 12, wherein the detecting step includes the following substep:
generating, by the second access point, a signal table storing the signal strength and at least one of (i) a strongest signal strength of a beacon received from the first access point, (ii) a weakest signal strength of a beacon received from the first access point, (iii) a sum of the signal strengths of all beacons received from the first access point and (iv) a sum of squares of the signal strengths of all beacons received from the first access point.

14. The method according to claim 13, further comprising:
updating the signal table by the second access point for each subsequent beacon received from the first access point.

15. The method according to claim 12, wherein the receiving the signal strength by the switch step includes the following substep:
communicating with the second access point according to a predetermined network management protocol.

16. The method according to claim 12, wherein the generating step includes the following substeps:
comparing the signal strength to the predetermined signal strength; and
when the signal strength is outside a predetermined range of the predetermined signal strength, executing the predetermined procedure.

17. The method according to claim 12, wherein the predetermined signal strength is generated during at least one of (i) a simulation of communication between the first and second access points and (ii) post-deployment communication between the first and second access points.

18. The method according to claim 12, wherein the output data is indicative of at least one of (i) at least one of the first and second access points is not in a corresponding predetermined location, (ii) a malfunction of at least one of the first and second access points and (iii) a difference between a designed physical environment and an actual physical environment in which the first and second access points are situated.

19. The method according to claim 12, wherein the executing step includes the following substep:
transmitting an alert to a network administrator.

20. An arrangement, comprising:
a communications arrangement receiving a signal strength of a wireless signal transmitted by a first access point and received by a second access point;
a memory storing a predetermined signal strength; and
a processor generating output data as a function of the signal strength and the predetermined signal strength, the processor executing a predetermined procedure which corresponds to the output data.

21. The arrangement according to claim 20, wherein the arrangement is a switch.

22. An arrangement, comprising:
a communication arrangement receiving a radio frequency signal from an access point;
a processor detecting a signal strength of the signal; and
a memory storing the signal strength in a signal table,
wherein the processor providing access to the signal table for a switch coupled to the communication arrangement,
wherein, the switch executes a predetermined procedure as a function of a comparison of the signal strength and a predetermined signal strength.

23. The arrangement according to claim 22, wherein the arrangement is one of an access point and an access port.
